(19) United States
(12) Patent Application Publication
(10) Pub. No.: US 2014/0106954 A1
(43) Pub. Date: Apr. 17, 2014

(54) DEVICE FOR MAKING A PAPER PAD PRODUCT

(71) Applicant: Storopack Hans Reichenecker GmbH, Metzingen (DE)

(72) Inventors: Paul Deis, Preuschdorf (FR); Jean-Marc Slovencik, Uhrwiller (FR)

(73) Assignee: Storopack Hans Reichenecker GmbH, Metzingen (DE)

(21) Appl. No.: 14/050,679

(22) Filed: Oct. 10, 2013

(30) Foreign Application Priority Data
Oct. 12, 2012 (DE) 10 2012 218 681.6

(51) Int. Cl. B31F 1/00

(52) U.S. Cl. CPC B31F 1/0009
USPC 493/464

(57) ABSTRACT

The present invention relates to a device (10) for manufacturing a cushioning product made of paper. The device comprises a crumpling machine (16), which compresses and/or crumples a paper web (34), a cutting machine (18) which is arranged thereafter viewed in the conveyance direction (38), and which detaches a section of the crumpled paper, and a discharge shaft (20) with a delivery channel (124), which leads the detached paper section to a delivery opening (123) of the delivery channel (124). A cross section height (W) and a curvature (K) of the delivery channel (124) are adapted to each other in such a manner that a typical user cannot reach the cutting machine (18) from the opening (123) through the delivery channel (124).

The present invention relates to a device for producing a cushioning product made of paper according to the preamble of claim 1.

Various methods and devices are known for manufacturing cushioning products produced by crumpling paper webs and used for filling hollow cavities when packing objects. They are based, for example, on first folding a paper web mechanically and then compressing it, which results in crumpling. Individual sections are then cut to a desirable length from this crumpled paper web, which is produced continuously. This can take place using a cutting machine in the same device. In preparation, the paper web can also be folded to the sideways before crumpling.

Thus, DE 102 42 998 A1 shows a device for producing a cushioning product made of paper, wherein the device comprises means for crumpling an endless paper web, in order to produce a crumpled paper tube by compression. For this purpose, a conveyor roller with counter roller and a crumpling roller with counter roller are arranged in the device, one after the other in the conveyance direction of the paper web. The conveyor roller is driven at a higher speed of rotation than the crumpling roller, resulting in the paper first being compressed between the two bearing roller pairs, and subsequently crumpled by the crumpling roller.

The problem of the present invention consists in providing a device for producing cushioning products made of paper, which can be operated safely by operating personnel.

To solve the problem, it is proposed that a cross section height and a curvature of a delivery channel of the device are adapted to each other in such a manner that a typical user cannot reach the cutting machine of the device from a delivery opening through the delivery channel.

It is understood here that the radius of curvature and the cross section height are very general dimensions that are located in the same plane.

The crumpled paper is detached by means of a tear off plate positioned in the cutting machine, on a principle similar to that of an accelerated guillotine or cleaver, forming cushioning sections which can be removed by the user. As a result of the invention, it is ensured that a user cannot be injured by the cutting machine. The invention is based on the idea of configuring and designing the device, particularly the discharge shaft of the device or portions thereof, in such a manner that the cutting machine cannot be reached by reaching into the delivery channel of the discharge shaft. The basic idea is that the human forearm is a nearly rigid rod which consequently cannot follow the curved course of the channel if the cross section height of the latter is sufficiently small. Here, the cross section height cannot be reduced in size at will, because otherwise the crumpled paper can no longer be led through it. The device according to the invention thus makes a considerable contribution to accident prevention. The proposed geometric design of the discharge channel at the same time makes it possible to keep said channel relatively short, so that the device is still a small construction.

Here, the delivery channel can comprise a round or angular cross section; it is preferable to use a rectangular cross section that is flat and broad. The delivery channel can be encased by a housing of the discharge shaft in such a manner that a visually appealing design results for the overall appearance of the device, entirely independently of possible complexity of the delivery channel.

It is also possible that, in the delivery channel, lamellas are arranged in the conveyance direction of the crumpled paper web, which assume an upright position when a person reaches through the delivery opening into the delivery channel, and thus prevent further introduction of the hand.

Alternatively or additionally it is possible for the discharge shaft to have the length of a typical human forearm. In this manner, possible reaching into the discharge shaft up to the cutting machine is prevented solely by the longitudinal extent of the discharge shaft. This possibility represents a simple and cost effective solution which, however, requires more installation space.

The purpose of all these designs is to increase the safety of the operating personnel during the operation of the device according to the invention, and to prevent accidents or injuries. Here, it must be taken into consideration that the device is preferably operated in packaging or shipping departments, where several persons use the device, and not all the persons are always trained extensively in operating the device.

In a preferred embodiment of the device, it is provided that the discharged channel is curved in the shape of an S. This makes it possible to orient the longitudinal axes of the inlet and of the outlet of the delivery channel at least approximately identically, that is at least approximately parallel to each other. Here, the curvatures (radii) of the S shape are sufficiently pronounced so that a human arm cannot follow the given shape of the delivery channel. The curvatures of the S shape can here extend horizontally and/or vertically. The curvatures should be selected to be as small as possible, so that the crumpled paper can follow the course of the delivery channel without problem.

In addition, it is provided that a free end section of the discharge shaft, which protrudes from the device, is arranged substantially horizontally or sloped downward. In this manner it is achieved that the expelled, crumpled paper automatically falls to the floor. There it can be collected first, for example, in a container, and then removed later in a desired quantity from the container during the packaging. In particular, in the embodiment which slopes downward, the risk of crumpled paper pieces remaining in the delivery channel is additionally prevented.

Furthermore, it is possible for the discharge shaft to have at least one side opening, which is optionally provided with a transparent cover, for observation of the detached paper section. As a result, potential operational malfunctions, such as, for example, a paper jam, in the discharge shaft can be detected, and subsequently they can be corrected rapidly and in a targeted manner by trained service personnel.

It is also possible to attach the discharge shaft in a detachable manner to a housing of the device. The housing of the device can here be self-supporting; however, it can also comprise a stable base frame, to which the discharge shaft is attached. The detachable attachment can be implemented, for example, by a simple and cost effective screw connection.

It is particularly convenient if the attachment comprises a latching connection. Here, the housing could comprise, for example, a groove that is open upward, into which a downward oriented hook of the discharge shaft can be hooked with positive locking against the force of gravity. On the opposite side of the groove/hook connection, the latching connection is arranged on the housing, with which the discharge shaft also engages with positive locking. The latching connection can be opened with a single movement of the hand. By means of such an attachment, the discharge shaft can be detached rapidly and simply for servicing work, and attached again, and it represents a reliable attachment of the discharge shaft to the housing.

In a particularly safely designed embodiment of the device, it is provided that the device comprises a safety element which prevents the operation of the device when the discharge shaft is not attached to the housing of the device. Here, the safety element can comprise a switch, for example, a magnetic switch or the like, which is arranged on a support surface of the discharge shaft on the housing. It is only if the discharge shaft is applied against the housing that a current circuit can be closed by means of the switch in order to operate the device according to the invention.

The safety element can alternatively also comprise, for example, a sensor, arranged on the support surface of the discharge shaft on the housing, for example, a pressure sensor, or a photodiode arranged there. It is only when the safety element detects the discharge shaft arranged on the housing that the current circuit is closed.

Additional characteristics, application possibilities and advantages of the invention can be obtained from the following description of an embodiment example of the invention which is represented in the drawing. Here, all the described or represented features by themselves or in any combination constitute the subject matter of the invention.

In the drawing:

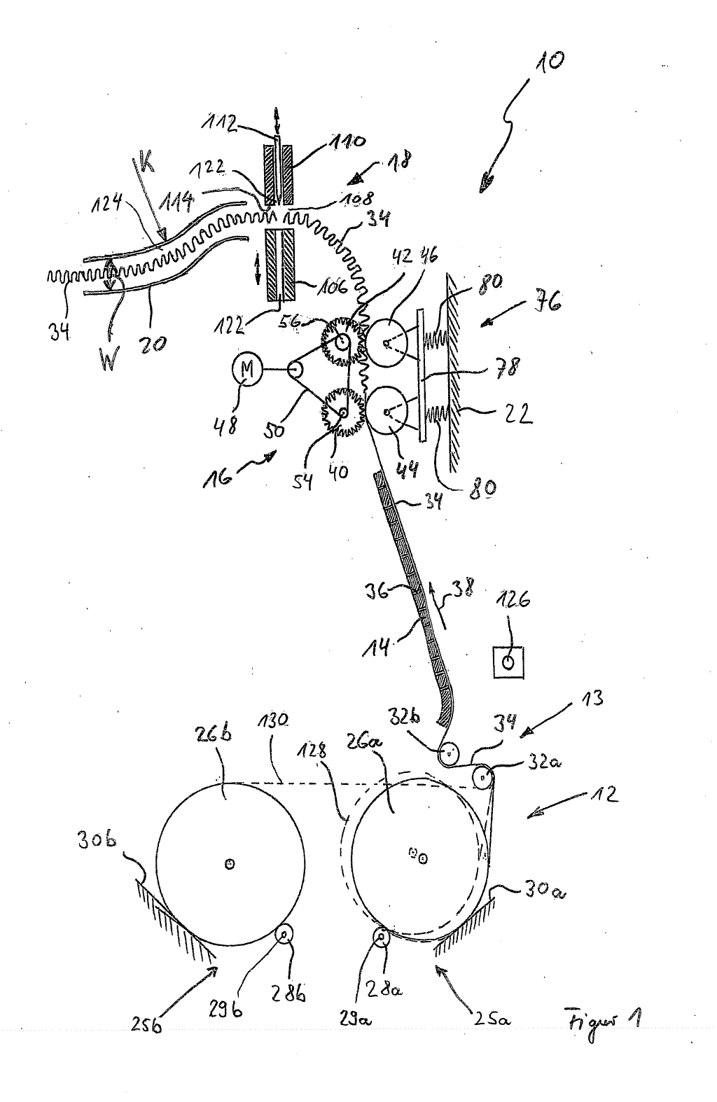

FIG. 1 shows a highly schematic side view of essential components of a device according to the invention for manufacturing a cushioning product made of paper;

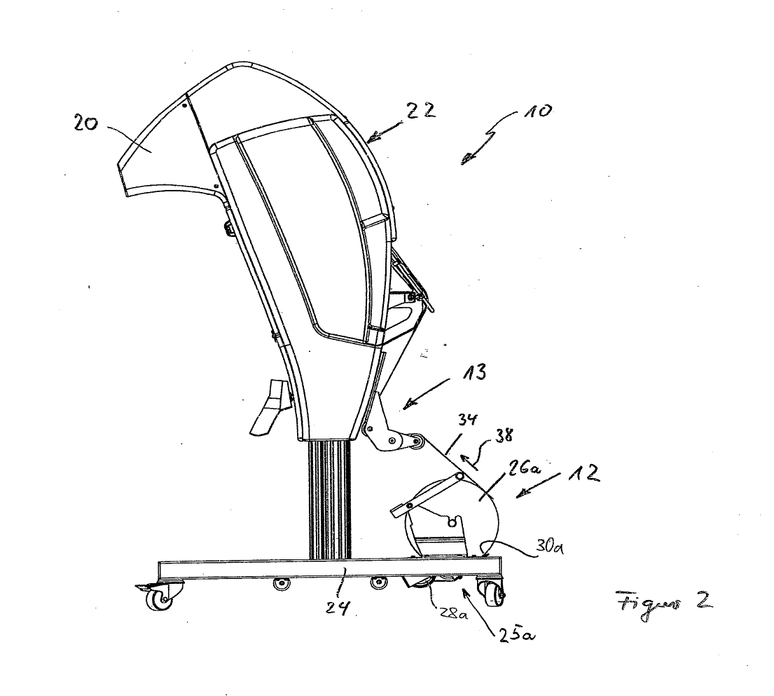

FIG. 2 shows a side view of the according to the invention for manufacturing a cushioning product made of paper;

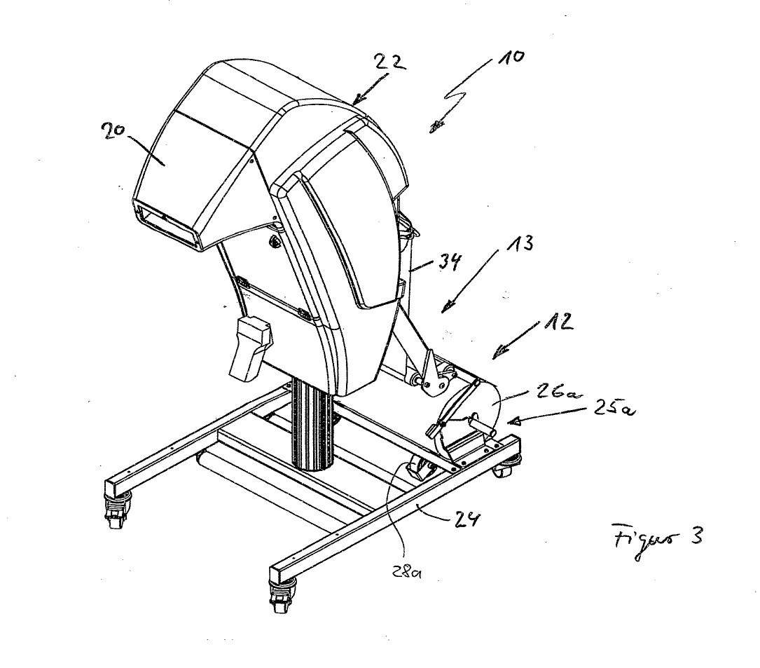

FIG. 3 shows a perspective view of the device of FIG. 2;

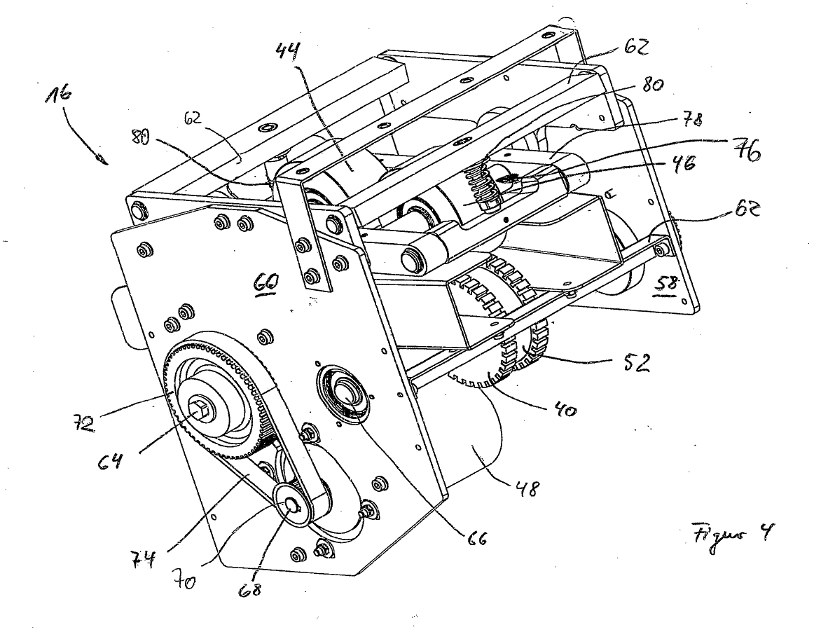

FIG. 4 shows a perspective view of a crumpling machine of the device according to the invention;

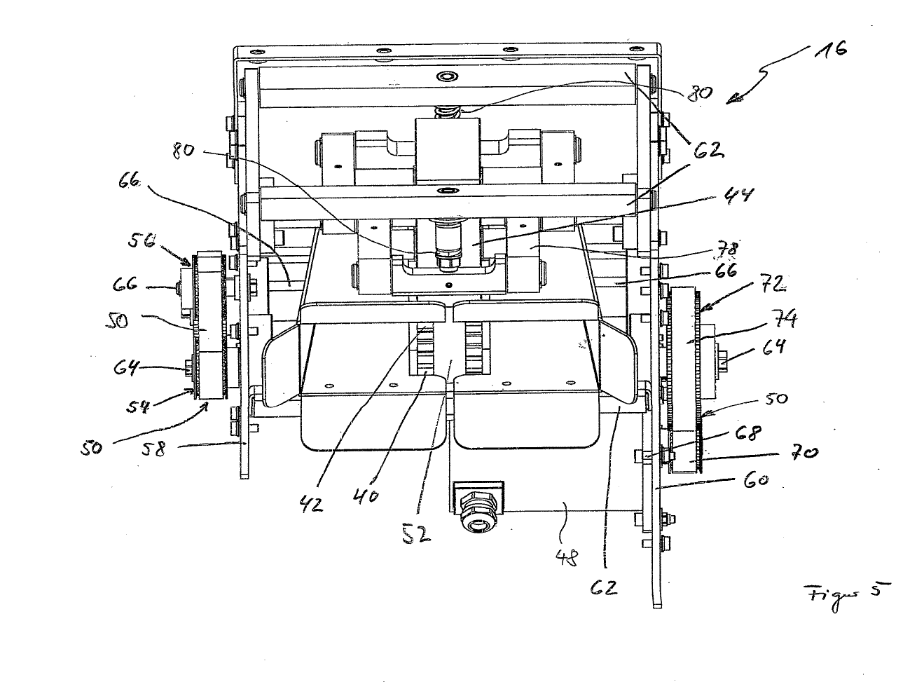

FIG. 5 shows a view from the top of the crumpling machine of FIG. 4;

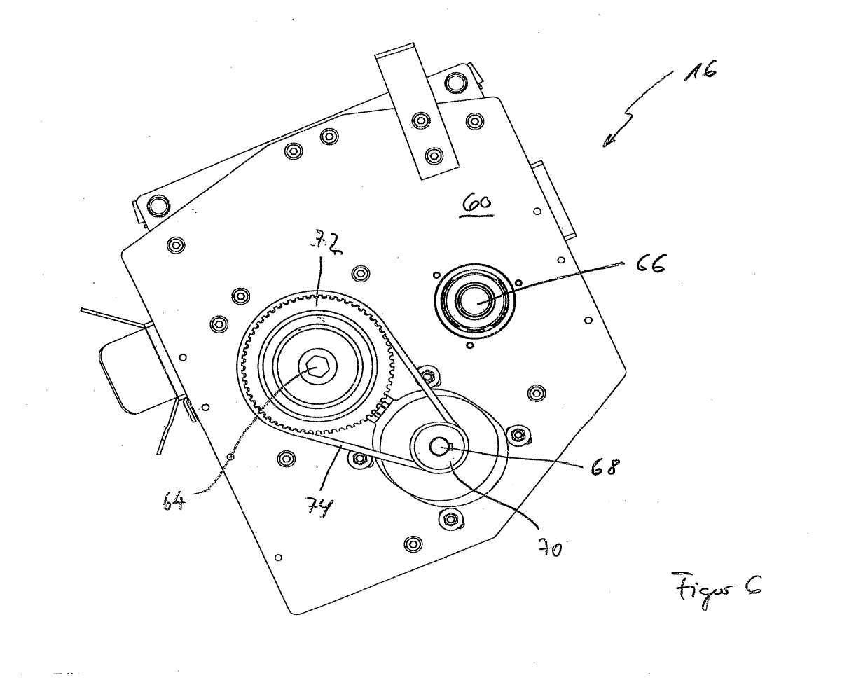

FIG. 6 shows a side view of the crumpling machine of FIG. 4 or 5;

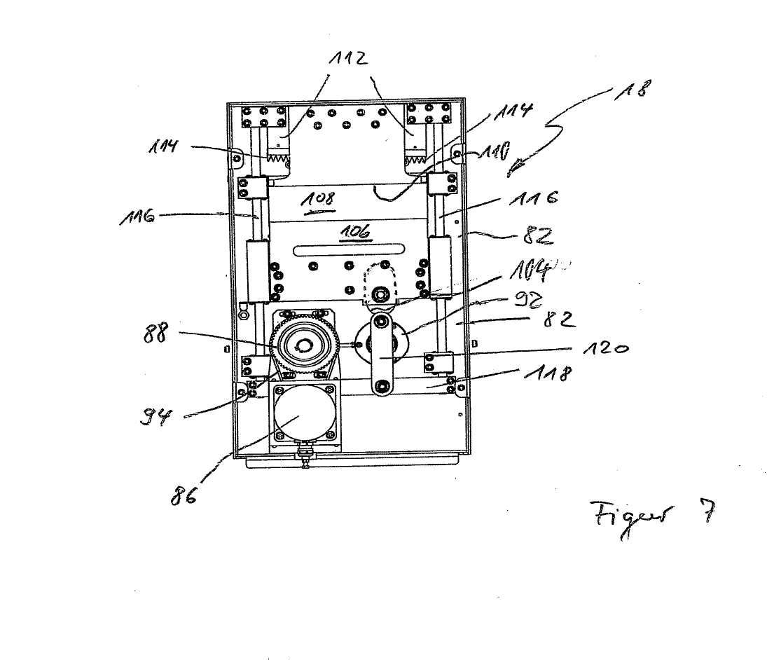

FIG. 7 shows a top view of a cutting machine of the device according to the invention from a first side; and

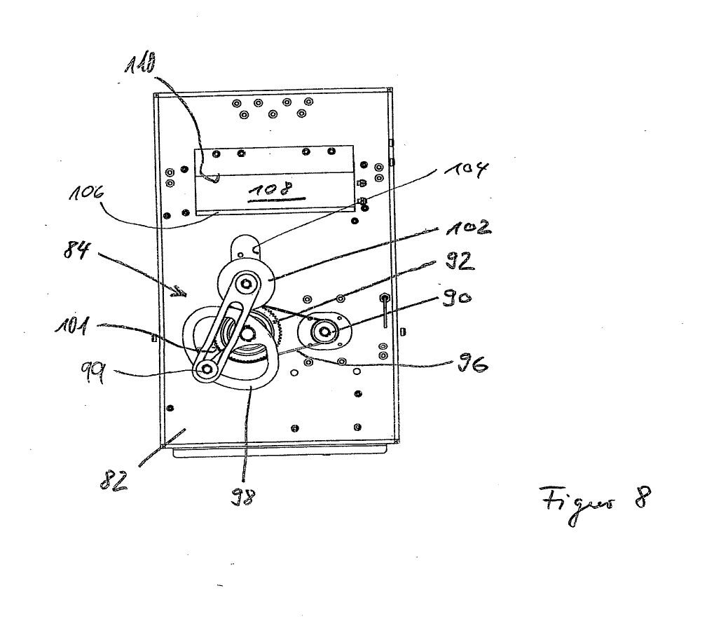

FIG. 8 shows a top view of a cutting machine of the device according to the invention from a second side.

FIG. 1 shows a highly schematic side view of essential components of a device 10 according to the invention for manufacturing a cushioning product made of paper. FIG. 2 shows a perspective side view of the device 10 from the outside; and FIG. 3 shows a perspective view of the device 10 of FIG. 2 at an angle from the top.

The device 10 comprises substantially a paper stock 12, a folding table 14, a crumpling machine 16, a cutting machine 18, and a discharge shaft 20. As can be seen in FIGS. 2 and 3, the folding table 14, the crumpling machine 16, and the cutting machine 18 are enclosed at least partially by a housing 22. Here the housing 22 can be self-supporting; however, it can also comprise a stable base frame. The housing 22 consists of multiple parts, so that the installations arranged in the housing 22 are accessible, for example, through closable doors. The device 10 is mounted by means of a travelling mechanism 24 on casters, in order to design the device 10 so that it can be moved locally.

The paper stock 12 can comprise two endless paper rolls 26a and 26b, wherein, in FIGS. 2 and 3, only the paper roll 26a is represented. Each paper roll 26a and 26b can have a weight of a few 100 kg. In the resting state of the device 10, the paper rolls 26a and 26b are mounted so they are doubly rotatable. On the one hand, the paper rolls 26a and 26b bear on a pair of rotating bearing rollers 28a and 28b, respectively, and, on the other hand, they bear on an inclined support surface 30a and 30b, respectively. The two support surfaces 30a and 30b are coated with a material or made of a material which has a high resistance to friction.

Via the deflection rollers 32a and 32b, a paper web 34 is supplied to the folding table 14. Multiple passage openings 36 are provided in the folding table 14.

The folding table 14, in conjunction with a side guide not represented in the drawing, is used to fold over the margins of the flat paper web 34, to form a flat paper tube in this manner. At the time of the transport of the paper web 34 on the folding table 14, air is entrained through the passage openings 36 into a gap between the paper web 34 and the folding table 14, so that the paper web 34 lies on an air cushion. As a result, the resistance between the paper web 34 and the folding table 14 is reduced.

In the conveyance direction 38 of the paper web 34, the crumpling machine 16 follows the folding table 14. FIGS. 4 and 5 show the interior of the crumpling machine 16 in detail. FIG. 4 here shows the crumpling machine 14 in a perspective view at an angle from the side; FIG. 5 shows the crumpling machine 16 in a view from above. The crumpling machine 16 comprises, viewed in the conveyance direction, first a conveyor roller 40 and then a crumpling roller 42. The conveyor roller 40 and the crumpling roller 42 are each associated with a counter roller 44, 46.

The conveyor roller 40 and the crumpling roller 42 are driven by a common drive motor 48 via a drive belt 50. The drive motor 48 is preferably a so-called step motor. The step motor offers the advantage that its speed can be adjusted with very high precision and that it can be stopped without substantial stopping time. A reverse operation is also possible without problem if needed.

According to the invention, the conveyor roller 40 and the crumpling roller 42 are identical in terms of their geometric dimension, the design of their peripheral faces, as well as the material used for their manufacture. Here, the two rollers 40, 42 can comprise at least in some sections a profiled, for example, a corrugated, peripheral face, as shown in FIGS. 4 and 5. The two counter rollers 44, 46 can also be of identical design, as shown particularly in FIG. 4. For example, they can both have a rubber-coated peripheral face. However, in an embodiment which is not represented, the counter rollers 44, 46 can also be identical to the conveyor roller 40 or to the crumpling roller 42, so that all four rollers 40, 42, 44 and 46 are identical.

The conveyor roller 40 and the crumpling roller 42 comprise a peripheral groove 52, according to FIGS. 4 and 5. In the groove 52, it is possible, on the one hand, for abrasion debris, particularly from the paper web 34, to collect. The groove 52 thus prevents an undesired deposit from forming on the peripheral face of the conveyor roller 40 and of the crumpling roller 42. On the other hand, the groove 52 offers an evasion space for the crumpled paper tube 34 during operation.

A belt pulley 54, 56 for driving by means of the drive belt 50 is associated with both the conveyor roller 40 and the crumpling roller 42. In the concrete embodiment of FIGS. 5 and 6, the crumpling machine 16 comprises two side holding plates 58 and 60, which are connected to each other by cross struts 62, as a result of which a cage-like and self-supporting housing construction for the crumpling machine 16 is produced. Both the conveyor roller 40 and also the crumpling roller 42 are rotatably mounted on rotating bearing shafts 64, 66, the ends of which in turn are rotatably mounted in the holding plates 58, 60. The drive motor 48 is arranged in the interior of the crumpling machine 16. Its drive shaft 68 passes outward through the holding plate 60, located on the right in FIG. 5. A drive belt pulley 70 is rotatably attached to the outer end of the drive shaft 68.

The bearing shaft 64 of the conveyor roller 40 passes through the holding plates 58 and 60. On an outer end of the bearing shaft 64 on the holding plate 60, a belt pulley 72 is arranged. The latter is coupled via a drive belt 74 to the drive belt pulley 70 of the drive motor 48 (see FIG. 6). The opposite outer end of the bearing shaft 64 of the conveyor roller 40 passes through the holding plate 58. On said end, the belt pulley 54 is arranged. The outer end of the bearing shaft 66 of the crumpling roller 42, which is located to the side, also passes through the holding plate 58. On said end, the belt pulley 56 is arranged. The two belt pulleys 54 and 56 are coupled by the drive belt 50 to each other.

As a result of the different diameters of the two belt pulleys 54 and 56, it is achieved that the conveyor roller 40 turns at approximately 1.5 times the speed of the crumpling roller 42. Here, it is also conceivable in another embodiment for the crumpling roller 42 and the belt pulley 56 associated with it as well as the conveyor roller 40 and the belt pulley 54 associated with it to form a single part.

In an alternative embodiment of the device 10, which is not represented, it is also possible for a drive shaft of the drive motor 48 to comprise two drive pulleys having different sizes, wherein a first drive pulley of the drive motor 48 having a larger diameter drives the conveyor roller 40, and a second drive pulley of the drive motor 48 having a smaller diameter drives the crumpling roller 42.

The two counter rollers 44, 46 are arranged on a prestressing device 76. The counter rollers 44, 46 are mounted within the prestressing device 76 on a shared frame-like support 78, which is braced, opposite the cross strut 62, by means of two mutually spaced adjustable spring elements 80 in a resilient manner. The counter rollers 44, 46 in this manner generate a pressure, which is adjustable for each counter roller, against the peripheral face of the conveyor roller 40 or of the crumpling roller 42, and they do not have their own drive.

In the conveyance direction 38 of the paper web 34, the cutting machine 18 follows the crumpling machine 16, and it is also configured as a modular unit on its own base plate 82. FIGS. 7 and 8 each show a top view on the cutting machine 18 from two opposite sides, wherein FIG. 7 shows the cutting machine 18 itself, and FIG. 8 shows a drive 84 of the cutting machine 18. One can see that the conveyance direction in the cutting machine 18, with respect to the conveyance direction in the crumpling machine 16, forms an angle, in the present case of approximately 90°.

The drive 84 is configured as a link controlled eccentric drive. The drive 84 comprises a step motor which in turn is configured as a drive motor 86, which is arranged on the side of the cutting machine 18 shown in FIG. 7, and which drives, via three toothed wheels 88, 90 and 92 and two toothed belts 94, 96, a link eccentric 98, which engages via a pin 99 in a movable manner in a slit 101 with a connection rod 100, and in this manner is connected to a link roller 102. The latter in turn is coupled with a slide, which is guided linearly in a longitudinal slit 104 present in the housing plate 82, and which is connected to a linearly guided clamping plate 106. The latter is arranged beneath a rectangular opening 108 in the housing plate 82, on the top side of which a stationary counter face 110 is located, which works together with the clamping plate 106 during operation.

Furthermore, the cutting machine 18 comprises a tear off plate 112 arranged above the opening 108, and provided with a tear off edge 114 which is set at a slant and provided with tear off teeth. The tear off plate 112 is connected by two side thrust rods 116, which are linearly guided on the housing plate 82, to a movable cross strut 118, which in turn is connected via a connection rod 120 to the toothed wheel 92 or to the link eccentric 98. The thrust rods 116 are here also a portion of the linear guide of the clamping plate 106. The tear off plate 112 is guided here in a recess 122 (see FIG. 1).

Moreover—viewed in the conveyance direction 38 of the paper web 34—the discharge shaft 20 follows the cutting machine 18 (FIGS. 1-3). The discharge shaft 20 comprises in the interior a longitudinal and in the present case S-shaped curved delivery channel 124 (see FIG. 1). A free end section of the discharge shaft 20, which protrudes from the device 10, is substantially arranged horizontally and sloped downward. The curvature K and the width W of the delivery channel 124 are selected in such a manner that a person is unable to reach the cutting machine 18 with the fingertips of his/her hand through a delivery opening 123 into the delivery channel 124. This can be further supported in that the discharge shaft 20 has at least the length of a typical human forearm.

The discharge shaft 20 is attached in a detachable manner to the housing 22. The attachment can comprise, for example, a screw connection (see screws 125 in FIGS. 2 and 3) or a latching connection. When using the latching connection (not shown), the housing 22 can comprise, for example, a groove which is open upward, into which a downward oriented hook of the discharge shaft 20 can be hooked with positive locking against the force of gravity. The latching connection is arranged on the opposite side of the groove/hook connection, and the discharge shaft 20 also engages with it with positive locking.

In order to improve accident prevention measures, the device 10 can comprise a safety element (not shown) which prevents the possibility of operating the device 10 when the discharge shaft 20 is not attached to the housing 22. Here, the safety element can comprise, for example, a switch, a pressure sensor or a photocell, wherein the safety element is arranged on a support surface of the discharge shaft 20 on the housing 22. It is only if discharge shaft 20 is applied against the housing 22 that, by means of the safety element, a current circuit is closed for the operation of the device 10 according to the invention.

In the vicinity of the paper rolls 26a and 26b, a switch 126 is provided for switching the device 10 on and off; said switch can preferably be actuated manually like a push-button, and it is connected to a control of the device 10, which is not shown in the drawing.

The device 10 works as follows: By switching the drive motor 48 on, the paper web 34 is pulled from the paper roll 26a by the conveyor roller 40 with its counter roller 44. As a result of the tensile force of the paper web 34, which is directed substantially upward in FIG. 1 onto the paper roll 26a, the latter rises slightly above the support surface 30a (see broken circular line 128), so that the paper roll 26a now bears substantially only on the bearing roller 28a, and thus it can be turned with low resistance. If the drive of the paper web 34 is interrupted, for example, in the case of a paper tear, the paper roll 26a falls back onto the support surface 30a. As a result of the friction between the support surface 30a and the paper roll 26a, the rotation of the paper roll 26a is strongly decelerated. Further rotation of the paper roll 26a, which is possible due to inertia, is prevented or at least strongly reduced.

Since two paper rolls 26a and 26b can be mounted in the device 10, the device 10 can be operated for a relatively long time, without having to procure a new paper roll from an external stock. Moreover, if the paper of the paper roll 26a has been used up, then the paper roll 26b can be used immediately, and it does not have to be taken out of its stock position for this purpose. This is represented in the drawing by a broken line 130. In addition, it is also possible to pull paper from the two paper rolls 26a and 26b simultaneously, that is to say to process a two-layered paper web 34 in the device 10.

In order to introduce the paper web 34 into the device 10, for example, after a paper tear, or if a new paper roll 26a or 26b has been started, one can also use a push-button 126, among other devices. By actuating the push-button 126, the drive motor 48 is set briefly in motion, which facilitates feeding it in. Due to the arrangement of the push-button 126 directly in the vicinity of the paper rolls 26a and 26b, the feeding in is facilitated and accelerated. The push-button 126 can also be used to run the crumpling machine 16 in reverse briefly, in order to remove any paper jam present.

The crumpling of the paper tube 34 in the crumpling machine 16 is achieved in a manner which in itself is known, by means of the conveyor roller 40 and the crumpling roller 42 which rotate at different rotation speeds, and the simultaneously rotating counter rollers 44, 46.

The compressed and crumpled paper web 34 is then supplied to the cutting machine 18. Upon the request of the operating personnel, the clamping plate 106 is first moved against the counter surface 110 by the above-described eccentric drive 84, and the crumpled paper web 34 is clamped as a result between the clamping plate 106 and the counter surface 110. As a result of the continued rotation of the toothed wheel 92, the tear off plate 112 is moved into the clamped and crumpled paper tube 34, and the latter is detached as a result. Due to the continued rotation of the eccentric drive 84, the tear off plate 112 and subsequently the clamping plate 106 are pulled back. A complete clamping and tearing off sequence is achieved by a 360° rotation of the toothed wheel 92 and of the link eccentric 98.

The crumpled and separated paper web 34 is moved by the next paper web into the delivery channel 124 of the discharge shaft 20. The compressed paper webs 34 detached by the cutting machine 18 can be removed at the protruding end of the discharge shaft 20. As a result of the longitudinally extending S shape of the discharge shaft 20, it is impossible to insert the arm or the hand, for example, in the case of a paper jam, so far into the discharge shaft 20 that there is a risk of the hand reaching the area of the cutting machine 18.

1. Device (10) for manufacturing a cushioning product made of paper, with a crumpling machine (16), which compresses and/or crumples a paper web (34), with a cutting machine (18) which is arranged thereafter viewed in the conveyance direction (38), and which detaches a section of the crumpled paper, and with a discharge shaft (20) with a delivery channel (124), which leads the detached paper section to a delivery opening (123) of the delivery channel (124), characterized in that a cross section height (W) and a curvature (K) of the delivery channel (124) are mutually adapted and/or a length of the delivery channel (124) is selected in such a manner that a typical user cannot reach the cutting machine (18) from the delivery opening (123) through the delivery channel (124).

2. Device (10) according to claim 1, characterized in that the delivery channel (124) is curved in the shape of an S.

3. Device (10) according to claim 1 or 2, characterized in that a free end section of the discharge shaft (20), which protrudes from the device (10), is substantially arranged horizontally or slanted downward.

4. Device (10) according to one of the previous claims, characterized in that the discharge shaft (20) comprises at least one side opening optionally provided with a transparent cover.

5. Device (10) according to one of the previous claims, characterized in that the discharge shaft (20) is attached in a detachable manner to a housing (22) of the device (20).

6. Device (10) according to claim 5, characterized in that the attachment comprises a latching connection.

7. Device (10) according to one of claims 6 or 7, characterized in that it comprises a safety element which prevents the possibility of operating the device (10) when the discharge shaft (20) is not attached to the housing (22) of the device (10).
